(19) United States
(12) Patent Application Publication
(10) Pub. No.: US 2026/0166986 A1
(43) Pub. Date: Jun. 18, 2026

(54) Day Tank

(71) Applicant: Fischer Panda Generators, LLC, Pompano Beach, FL (US)

(72) Inventor: Kyle Riebel, Pompano Beach, FL (US)

(73) Assignee: Fischer Panda Generators, LLC, Pompano Beach, FL (US)

(21) Appl. No.: 19/422,976

(22) Filed: Dec. 17, 2025

Related U.S. Application Data
(60) Provisional application No. 63/735,165, filed on Dec. 17, 2024.

(51) Int. Cl. B60K 15/035; B01D 17/02; B01D 19/00; B60K 15/03

(52) U.S. Cl. CPC B60K 15/035; B01D 17/02; B01D 19/0063; B60K 2015/03118; B60K 2015/0319; B60K 2015/03217; B60K 2015/03236; B60K 2015/03243; B60K 2015/03289

(57) ABSTRACT

A fuel management system comprising a day tank configured to receive fuel from a chassis fuel tank and to receive return fuel from a generator; a fuel level sensor configured to generate a fuel-level signal indicative of an amount of fuel within the day tank; a fuel pump transfers fuel from the chassis fuel tank to the day tank; a pressure switch generates a pressure signal indicative of an over-pressure condition within the day tank; a fuel venting assembly configured to vent air and vapor from the day tank; a fuel strainer; a generator fuel pump, a fuel filter/water separator, a control circuit actuates the fuel pump when the amount of fuel in the day tank is below a first threshold, deactivate the fuel pump when the amount of fuel in the day tank is above a second threshold, and deactivate the fuel pump upon detection of the over-pressure condition.

### CLAIM FOR PRIORITY

This application claims priority from prior provisional patent application 63/735,165 filed on Dec. 17, 2024. The entire collective teachings thereof being herein incorporated by reference.

### TECHNOLOGICAL FIELD

Example embodiments of the present disclosure generally relate to day tanks, and more particularly relate to a fuel management system for supplying fuel to a generator mounted on a vehicle chassis, the system incorporating a day tank configuration for controlled storage, circulation, and delivery of fuel from a chassis fuel tank to a generator mounted on the vehicle chassis.

### BACKGROUND

Conventional fuel management systems used on vehicles equipped with chassis-mounted diesel generators are commonly designed to draw fuel from the primary chassis tank and return unused fuel back to the same tank. However, certain chassis platforms impose a critical limitation: return fuel is not permitted to flow back into the chassis tank. This restriction renders traditional closed-loop fuel systems incompatible, particularly for generator installations requiring a continuous return path. Earlier solutions, including day-tank configurations originally adapted for such platforms, attempted to address the return-fuel constraint but proved inadequate because they continued to route return fuel to the chassis tank, thereby failing to meet the underlying operational requirements.

Such limitations revealed a broader challenge: the absence of a universal diesel fuel system capable of reliably supplying generator fuel on a range of vehicle chassis while complying with return-fuel restrictions. Prior day-tank solutions lacked essential functionalities expected by end users, including proper tank venting and integrated fuel-level sensing. Without these features, the system could not autonomously control the fuel pump nor maintain stable fuel levels, resulting in inconsistent generator operation. Safety mechanisms such as pressure-based shutoff devices critical for preventing overfill events were also missing, leaving systems susceptible to overflow under certain conditions.

Diesel generator operation introduces additional complexity. Diesel fuel returning from the engine's injection system typically contains entrained air due to inherent aeration effects, and routing this aerated fuel directly back into the generator or tank without proper deaeration can result in unstable combustion, pump cavitation, and erratic generator performance. Returning fuel may also be warmer than desired, requiring careful temperature regulation to remain within the operating requirements established for the generator's engine.

Many methods and devices have been used unsuccessfully in attempts to efficiently and effectively provide simple and easy-to-use systems for integrating diesel fuel supply arrangements into specific vehicle chassis configurations. Numerous aftermarket devices, auxiliary systems, and workaround approaches have been developed in an effort to accommodate diesel-based generator and auxiliary loads while still preserving original-equipment manufacturer warranty requirements. In many installations, separate fuel sources are employed to supply both the primary vehicle propulsion system and various auxiliary components, such as water-heating units or diesel-fired air heaters. These multi-source arrangements increase installation complexity and introduce additional operational burdens on the end user. Furthermore, existing approaches often require standalone components combined into ad hoc customized systems, leading to maintenance procedures that are more involved and less predictable. Current fuel-supply arrangements therefore do not provide a straightforward, reliable, or efficient means of delivering a unified fuel source for both vehicle power and auxiliary onboard functions.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a fuel management system for supplying fuel to a generator mounted on a vehicle chassis comprising a chassis fuel tank is disclosed. The fuel management system comprises a day tank positioned separately from the chassis fuel tank and configured to receive fuel from the chassis fuel tank and to receive return fuel from the generator. The fuel management system further comprises a fuel level sensor disposed in the day tank and configured to generate a fuel-level signal indicative of an amount of the fuel within the day tank. The fuel management system further comprises a day tank fuel pump fluidly connected between the chassis fuel tank and the day tank, the fuel pump being configured to transfer the fuel from the chassis fuel tank to the day tank. The fuel management system further comprises a pressure switch fluidly coupled to the day tank and configured to generate a pressure signal indicative of an over-pressure condition within the day tank. The fuel management system further comprises a fuel venting assembly fluidly coupled to the day tank and configured to vent air and vapor from the day tank to provide deaeration of the return fuel received from the generator. The vent also allows air and vapor to enter and escape as fuel is being consumed or the tank is being filled. The fuel management system further comprises a fuel strainer fluidly coupled to an outlet of the day tank. The fuel management system further comprises a generator fuel pump to provide fuel to the generator. The fuel management system further comprises a fuel filter/water separator. The fuel management system further comprises a control circuit operatively coupled to the fuel level sensor, the day tank fuel pump, and the pressure switch, the control circuit being configured to actuate the day tank fuel pump to transfer fuel from the chassis fuel tank to the day tank when the fuel-level signal indicates that the amount of fuel in the day tank is below a first threshold, deactivate the day tank fuel pump when the fuel-level signal indicates that the amount of fuel in the day tank is above a second threshold, and deactivate the day tank fuel pump upon detection of the over-pressure condition indicated by the pressure signal.

In some embodiments, the fuel management system is configured such that deaerated fuel within the day tank is supplied to the generator while entrained air in the return fuel is removed due to natural means while the fuel is near undisturbed in the day tank. Some of this entrained air may exit the day tank via the fuel venting assembly.

In some embodiments, the fuel management system further comprising a generator fuel supply line extending from the fuel strainer, day tank fuel pump, fuel filter/water separator to the generator and configured to deliver fuel from the day tank to the generator, and a generator fuel return line extending from the generator to the day tank and configured to return unused fuel from the generator to the day tank. Further, the generator fuel return line is fluidly isolated from the chassis fuel tank such that return fuel from the generator is prevented from entering the chassis fuel tank.

In some embodiments, the fuel venting assembly comprises a float valve configured to prevent liquid fuel discharge during overfill conditions and further comprises a rollover valve configured to prevent fuel leakage during an inversion of the vehicle chassis.

In some embodiments, the control circuit is further configured to prevent activation of the fuel pump when a fuel level of the chassis fuel tank is below a predetermined chassis-fuel threshold.

In some embodiments, the control circuit is further configured to deactivate the fuel pump when the fuel pump has operated continuously for a predetermined maximum runtime without the fuel level sensor indicating that the amount of fuel in the day tank has reached the second threshold.

In some embodiments, the control circuit is further configured to inhibit subsequent activation of the fuel pump after expiration of the predetermined maximum runtime until at least one of: (i) a timeout interval has elapsed; or (ii) electrical power to the control circuit has been cycled.

In some embodiments, the generator fuel pump is selected to provide a flow rate sufficient to overcome entrained-air accumulation within the generator fuel supply line during generator restart conditions.

In some embodiments, the generator fuel supply line and the generator fuel return line comprise SAE-rated fuel lines sized to reduce the formation of air pockets and reduce the number of required hose connections.

In some embodiments, the fuel filter/water separator and the generator fuel supply line are arranged such that small air bubbles introduced by the generator, fuel transfer process, and generator fuel pump are dissipated within the filter/water separator prior to entering the generator.

In some embodiments, the day tank is mounted at an elevation above an elevation of the chassis fuel tank to inhibit siphoning of fuel from the chassis fuel tank into the day tank when the fuel pump is deactivated.

In some embodiments, the day tank is configured to supply diesel fuel to at least one auxiliary fuel-consuming device selected from: (i) a diesel-fired cabin heater; and (ii) a diesel-fired water heater.

In some embodiments, the day tank is dimensioned to provide a reserve supply of fuel for the generator.

In some embodiments, the chassis fuel tank includes a manufacturer-provided fuel pickup port having a predetermined depth that terminates above a bottom of the chassis fuel tank to prevent depletion of fuel required for chassis propulsion.

In some embodiments, the control circuit is further configured to maintain the fuel level in the day tank within an operating band between approximately 40 percent and 90 percent of a capacity of the day tank during generator operation.

In another example embodiment, a method is disclosed. The method comprises steps of positioning separately a day tank from a chassis fuel tank mounted on a vehicle chassis and the day tank being configured to receive fuel from the chassis fuel tank and to receive return fuel from a generator. The method further comprises steps of disposing a fuel level sensor in the day tank, the fuel level sensor being configured to generate a fuel-level signal indicative of an amount of fuel within the day tank. The method further comprises steps of connecting a day tank fuel pump fluidly between the chassis fuel tank and the day tank, the fuel pump being configured to transfer fuel from the chassis fuel tank to the day tank. The method further comprises steps of fluidly coupling a pressure switch to the day tank and the pressure switch being configured to generate a pressure signal indicative of an over-pressure condition within the day tank. The method further comprises steps of fluidly coupling a fuel venting assembly to the day tank, the fuel venting assembly being configured to vent air and vapor from the day tank to provide deaeration of the return fuel received from the generator. The vent also allows air and vapor to enter and escape as fuel is being consumed or the tank is being filled. The method further comprises steps of fluidly coupling a fuel strainer to an outlet of the day tank. The method further comprises steps of providing, via a generator fuel pump, fuel to the generator. The method further comprises steps of providing a fuel filter/water separator. The method further comprises steps of actuating, via a control circuit, the day tank fuel pump to transfer fuel from the chassis fuel tank to the day tank when the fuel-level signal indicates that the amount of fuel in the day tank is below a first threshold. The method further comprises steps of deactivating, via the control circuit, the day tank fuel pump when the fuel-level signal indicates that the amount of fuel in the day tank is above a second threshold. The method further comprises steps of deactivating, via the control circuit, the day tank fuel pump upon detection of the over-pressure condition indicated by the pressure signal.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a fuel management system in accordance with an example embodiment of the present disclosure;

FIG. 2 illustrates an architectural view of a portion of the fuel management system in accordance with an example embodiment of the present disclosure;

FIG. 3 illustrates a perspective view of a day tank of the fuel management system in accordance with an example embodiment of the present disclosure;

FIG. 4 illustrates a perspective view of a day tank fuel pump of the fuel management system in accordance with an example embodiment of the present disclosure;

FIG. 5 illustrates a circuit diagram of the fuel management system in accordance with an example embodiment of the present disclosure;

FIG. 6 illustrates an architectural view showing a fuel level indicator of the fuel management system in accordance with an example embodiment of the present disclosure;

FIG. 7 illustrates an isometric view of the day tank with a mounting assembly in accordance with an example embodiment of the present disclosure;

FIG. 8 illustrates an exploded view of the mounting assembly of the day tank in accordance with an example embodiment of the present disclosure; and

FIG. 9 illustrates a flowchart showing a method in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a fuel management system. The fuel management system may comprise a day tank positioned separately from a chassis fuel tank mounted on a vehicle chassis and may be configured to receive fuel from the chassis fuel tank and to receive return fuel from a generator. The fuel management system may further comprise a fuel level sensor disposed in the day tank and may be configured to generate a fuel-level signal indicative of an amount of fuel within the day tank. The fuel management system may further comprise a day tank fuel pump fluidly connected between the chassis fuel tank and the day tank, the fuel pump may be configured to transfer fuel from the chassis fuel tank to the day tank. The fuel management system may further comprise a pressure switch fluidly coupled to the day tank and may be configured to generate a pressure signal indicative of an over-pressure condition within the day tank.

The fuel management system may further comprise a fuel venting assembly fluidly coupled to the day tank and may be configured to vent air and vapor from the day tank to provide deaeration of the return fuel received from the generator. The vent also allows air and vapor to enter and escape as fuel is being consumed or the tank is being filled. The fuel management system may further comprise a fuel strainer fluidly coupled to an outlet of the day tank. The fuel management system may further comprise a generator fuel pump to provide fuel to the generator. The fuel management system may further comprise a fuel filter/water separator. The fuel management system may further comprise a control circuit operatively coupled to the fuel level sensor, the fuel pump, and the pressure switch, the control circuit may be configured to actuate the day tank fuel pump to transfer fuel from the chassis fuel tank to the day tank when the fuel-level signal indicates that the amount of fuel in the day tank may be below a first threshold, deactivate the day tank fuel pump when the fuel-level signal indicates that the amount of fuel in the day tank may be above a second threshold, and deactivate the day tank fuel pump upon detection of the over-pressure condition may be indicated by the pressure signal.

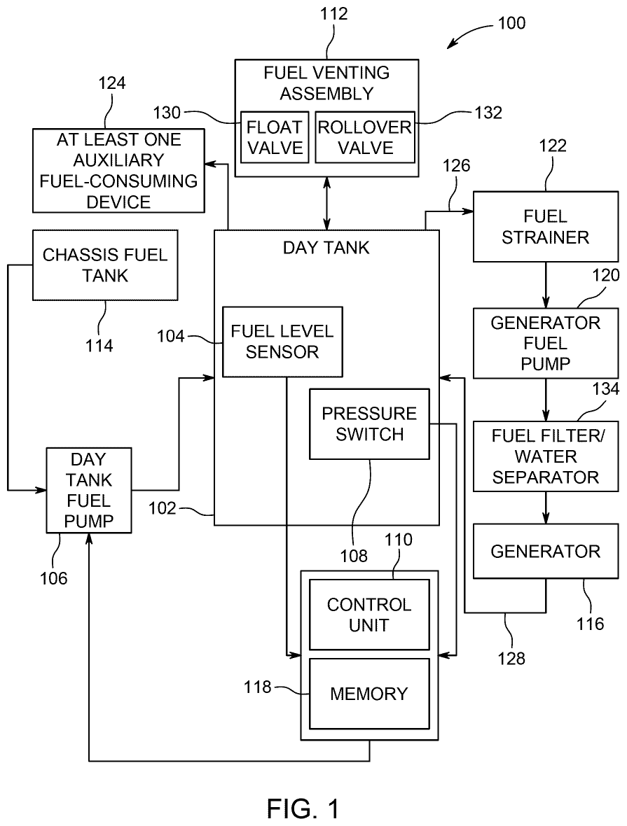

FIG. 1 illustrates a block diagram of a fuel management system 100, in accordance with an example embodiment of the present disclosure.

In some embodiments, the fuel management system 100 may comprise a day tank 102, a fuel level sensor 104, and a day tank fuel pump 106. The fuel management system 100 may further comprise a pressure switch 108, a control circuit 110, and a fuel venting assembly 112. In some embodiments, the fuel management system 100 may be installed within a vehicle (not shown). The vehicle may comprise at least van, motor home, caravan or the like. In some embodiments, the vehicle may comprise a vehicle chassis (not shown), vehicle body (not shown), on-board appliances (not shown), or the like. The vehicle chassis may be configured to provide structural integrity to the vehicle. The vehicle chassis may comprise structural steel or aluminum longitudinal rails, cross-members, suspension mounting points, engine cradles, and underbody brackets. The vehicle chassis may further comprise pre-formed cable channels, Original Equipment Manufacturer (OEM) fuel line conduits, vibration-isolated mounting points, and protected routing corridors that may enable installation of fuel pumps, valves, and fuel transfer components.

In some embodiments, the vehicle chassis may be installed with a chassis fuel tank 114. In some embodiments, the chassis fuel tank 114 may be configured to store fuel. The chassis fuel tank 114 may be fluidly coupled with an OEM fuel pump (not shown). Further, the OEM fuel pump may be configured to supply the fuel from the chassis fuel tank 114 to a power train (not shown) of the vehicle through fuel supply lines (not shown). In some embodiments, the vehicle body may be configured to support installation of interior systems and housing of various mechanical and electrical components associated with the vehicle. The vehicle body may comprise exterior panels, interior panels, under-floor storage compartments, insulation equipment, or the like.

In some embodiments, the on-board appliances may be configured to operate from a 12V/24V/48V Direct Current (DC) system or a 120V/230V Alternating Current (AC) system. In some embodiments, the on-board appliances may comprise Heating, Ventilation, Air-Conditioning (HVAC) systems, refrigerators, induction cooktops, water heaters, entertainment modules, lighting subsystems, and other auxiliary electronic equipment. The on-board appliances may generate dynamic load demands that require stable power generation, prompting integration of a generator 116. The vehicle may also be installed with the generator 116. In an exemplary embodiment, the generator 116 may correspond to a diesel generator. The generator 116 may be mounted on the vehicle chassis. In some embodiments, the generator 116 may be configured to provide a regulated power supply to the on-board appliances. In some embodiments, the generator 116 may require a stable and contamination-free diesel fuel supply delivered at a specified pressure, temperature, and volumetric flow rate to generate the regulated power supply.

In some embodiments, the fuel management system 100 may be configured for supplying the fuel to the generator 116. The fuel management system 100 may comprise the day tank 102. In some embodiments, the day tank 102 may be positioned separately from the chassis fuel tank 114. Further, the day tank 102 may be configured to receive fuel from the chassis fuel tank 114. Further, the day tank 102 may be configured to receive return fuel from the generator 116. In some embodiments, the day tank 102 may be configured to operate as an intermediate fuel reservoir between the chassis fuel tank 114 and the generator 116. The day tank 102 may be configured to maintain a predetermined amount of fuel to ensure a consistent fuel availability for the generator 116 during varying load conditions.

In some embodiments, the fuel management system 100 may comprise the fuel level sensor 104. Further, the fuel level sensor 104 may be disposed in the day tank 102. In some embodiments, the fuel level sensor 104 may be configured to measure an amount of fuel within the day tank 102. The fuel level sensor 104 may comprise one or more sensing elements such as a float-based mechanism, a resistive strip, a capacitive probe, an ultrasonic sensing unit, or the like. The one or more sensing elements configured to detect the amount of fuel within the day tank 102. Further, the fuel level sensor 104 may be configured to generate a fuel-level signal indicative of the amount of fuel within the day tank 102. The fuel level sensor 104 may be an ohmic-based resistive sensor configured to generate a resistance value corresponding to the amount of fuel in the day tank 102. In some embodiments, the fuel level sensor 104 may be operatively coupled to the control circuit 110. The fuel level sensor 104 may be configured to transmit the fuel-level signal to the control circuit 110.

In some embodiments, the fuel management system 100 may comprise the day tank fuel pump 106. The day tank fuel pump 106 may be fluidly connected between the chassis fuel tank 114 and the day tank 102. In some embodiments, the day tank fuel pump 106 may be configured to transfer the fuel from the chassis fuel tank 114 to the day tank 102. The day tank fuel pump 106 may comprise at least an electric pump, mechanical pump, or diaphragm-type pump configured to generate sufficient suction and discharge pressure to transfer the fuel from the chassis fuel tank 114 to the day tank 102. In some embodiments, the fuel management system 100 may comprise the pressure switch 108. In some embodiments, the pressure switch 108 may be fluidly connected to the day tank 102. In some embodiments, the pressure switch 108 may be configured to generate a pressure signal indicative of an over-pressure condition within the day tank 102. In some embodiments, the pressure switch 108 may be fluidly connected to the day tank 102 through a dedicated pressure port or integrated pressure sensing interface. The pressure switch 108 may be configured to continuously monitor the internal pressure conditions within the day tank 102 and generate the pressure signal indicative of the over-pressure condition.

In some embodiments, the fuel management system 100 may comprise the control circuit 110 and a memory 118. Further, the control circuit 110 may be operationally coupled to the fuel level sensor 104, the day tank fuel pump 106, the pressure switch 108, and the memory 118. In some embodiments, the control circuit 110 may include suitable logic, circuitry, and/or interfaces that are operable to execute one or more computer readable instructions stored in the memory 118 to perform predetermined operations. In one embodiment, the control circuit 110 may be configured to decode the one or more instructions and execute the one or more instructions that are stored within the memory 118. The control circuit 110 may be configured to execute the one or more computer readable instructions, such as program instructions to carry out any of the functions described in this description. Further, the control circuit 110 may be implemented using one or more technologies known in the art such as central processing unit (CPU), field-programmable gate array (FPGA), digital signal processors (DSP), etc. Examples of the control circuit 110 may comprise at least one of one or more general purpose processors/controllers and/or one or more special purpose processors/controllers that may be designed to handle the fuel management system 100.

In some embodiments, the control circuit 110 may be configured to receive the fuel-level signal from the fuel level sensor 104. In some embodiments, the control circuit 110 may be configured to compare the amount of fuel in the day tank 102 indicated by the fuel-level signals with a first threshold and a second threshold. Further, the control circuit 110 may be configured to actuate the day tank fuel pump 106 when the fuel-level signal may indicate that the amount of fuel in the day tank 102 is below the first threshold. Upon actuating, the day tank fuel pump 106 may be configured to transfer the fuel from the chassis fuel tank 114 to the day tank 102. For example, the day tank 102 may have a total capacity of 1.9 gallons. The fuel-level signal may indicate that the day tank 102 currently contains less than 30% of its capacity, such as approximately 0.6 gallons of fuel. The first threshold may correspond to 40% of the day tank 102 capacity, such as approximately 0.8 gallons. In such scenarios, the control circuit 110 may be configured to actuate the day tank fuel pump 106 when the fuel-level signal may indicate that the amount of fuel in the day tank 102 is below the first threshold. Upon actuating, the day tank fuel pump 106 may be configured to transfer the fuel from the chassis fuel tank 114 to the day tank 102.

While the day tank fuel pump 106 transfers the fuel from the chassis fuel tank 114 to the day tank 102, the fuel level sensor 104 may continuously monitor the amount of fuel within the day tank 102. In some embodiments, the control circuit 110 may be further configured to maintain the fuel level in the day tank 102 within an operating band between approximately 40 percent and 90 percent of a capacity of the day tank 102 during generator operation. In some embodiments, the control circuit 110 may be configured to receive the fuel-level signal from the fuel level sensor 104, while the day tank fuel pump 106 transfers the fuel. In some embodiments, the control circuit 110 may be configured to compare the amount of fuel in the day tank 102 indicated by the fuel-level signals with the second threshold. Further, the control circuit 110 may be configured to deactivate the day tank fuel pump 106 when the fuel-level signal may indicate that the amount of fuel in the day tank 102 is above the second threshold. Upon deactivation, the day tank fuel pump 106 may stop transferring of the fuel from the chassis fuel tank 114 to the day tank 102. For example, the second threshold may correspond to more than 90% of the day tank 102 capacity, such as approximately 1.7 gallons. Further, the control circuit 110 may be configured to deactivate the day tank fuel pump 106 when the fuel-level signal may indicate that the amount of fuel in the day tank 102 is above the second threshold. Upon deactivation, the day tank fuel pump 106 may stop transferring the fuel from the chassis fuel tank 114 to the day tank 102.

In some embodiments, the control circuit 110 may be configured to receive the pressure signal from the pressure switch 108. Further, the pressure signal may indicate an over-pressure condition within the day tank 102. In some embodiments, the control circuit 110 may be configured to deactivate the day tank fuel pump 106 upon detection of the over-pressure condition indicated by the pressure signal. For example, the day tank 102 may be designed to operate at a nominal internal pressure of near 0 psi during normal fuel transfer. Further, the pressure switch 108 may be configured to generate the pressure signal when the internal pressure of the day tank 102 exceeds an over-pressure threshold, such as 2 psi. In some embodiments, the control circuit 110 may be configured to deactivate the day tank fuel pump 106 upon detection of the over-pressure condition indicated by the pressure signal. Upon deactivation, the day tank fuel pump 106 may stop transferring fuel from the chassis fuel tank 114 to the day tank 102 to prevent further pressure build-up and ensure safe operation.

In some embodiments, the control circuit 110 may be further configured to prevent activation of the day tank fuel pump 106 when a fuel level of the chassis fuel tank 114 is below a predetermined chassis-fuel threshold. he predetermined chassis-fuel threshold may correspond to a minimum reserve level required for vehicle propulsion. The control circuit 110 may receive a chassis-fuel-level signal via a CAN communicaiton signal from the chassis. The chassis-fuel-level signal may indicate the fuel level of the chassis fuel tank 114. For example, the chassis fuel tank 114 may have a total capacity of 26.4 gallons, and the predetermined chassis-fuel threshold may correspond to 19% of capacity, such as approximately 5 gallons. When the chassis-fuel-level signal indicates that fuel level of the chassis fuel tank 114 is below 5 gallons, the control circuit 110 may prevent activation of the day tank fuel pump 106 to avoid damage to the day tank fuel pump by actuating it without fuel. Furthermore a warning will be displayed indicating such condition. If such condition is present, reactivation of the fuel pump would be allowed if the chassis tank returns to above 19% of capacity. All percentage setpoints are adjustable in software to allow for different chassis and day tank configurations.

In some embodiments, the control circuit 110 may be further configured to deactivate the day tank fuel pump 106 when the day tank fuel pump 106 may have operated continuously for a predetermined maximum runtime without the fuel level sensor 104 indicating that the amount of fuel in the day tank 102 may have reached the second threshold. The predetermined maximum runtime may correspond to a safety duration intended to prevent prolonged pump operation in the event of a blocked line, empty chassis tank, pump malfunction, or sensor failure. For example, the predetermined maximum runtime may be configured as 360 seconds. when the day tank fuel pump 106 may operate for 360 consecutive seconds without the fuel-level signal indicating that the day tank 102 may have reached the second threshold (such as approximately 1.7 gallons for a 1.9-gallon tank), the control circuit 110 may deactivate the day tank fuel pump 106 to prevent overheating or damage of the day tank fuel pump 106.

In some embodiments, the control circuit 110 may be further configured to inhibit subsequent activation of the day tank fuel pump 106 after expiration of the predetermined maximum runtime until at least one of timeout interval has elapsed or electrical power to the control circuit 110 has been cycled. For example, after the day tank fuel pump 106 may be deactivated due to exceeding the predetermined maximum runtime, the control circuit 110 may inhibit activation of the day tank fuel pump 106 for the timeout interval such as 15 minutes may be elapsed. After one timeout interval, the control circuit 110 will allow the day tank fuel pump 106 to run for another 360 seconds. After this second 360 second runtime has completed and the day tank fuel level has not reached 90% or greater, the control system 110 will prevent further activation of the fuel pump until the control system 110 is powered off and then back on.

In some embodiments, the memory 118 may be configured to store the one or more computer readable instructions and data executed by the control circuit 110. Further, the memory 118 may include the one or more computer readable instructions that are executable by the control circuit 110 to perform specific operations. The memory 118 may be configured to include the instructions to actuate the day tank fuel pump 106 to transfer fuel from the chassis fuel tank 114 to the day tank 102 when the fuel-level signal may indicate that the amount of fuel in the day tank 102 is below the first threshold. Further, the memory 118 may be configured to include the instructions to deactivate the day tank fuel pump 106 when the fuel-level signal may indicate that the amount of fuel in the day tank 102 is above the second threshold. Further, the memory 118 may be configured to include the instructions to deactivate the day tank fuel pump 106 upon detection of the over-pressure condition indicated by the pressure signal. The memory 118 may be configured to store the one or more computer readable instructions.

It is apparent to a person with ordinary skill in the art that the one or more computer readable instructions stored in the memory 118 enable the hardware of the system to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the generator 116 may comprise a generator fuel pump 120. In some embodiments, the generator fuel pump 120 of the generator 116 may be fluidly coupled to the day tank 102. In some embodiments, the generator fuel pump 120 may be configured to provide the fuel to the generator 116. In some embodiments, the generator fuel pump 120 of the generator 116 may be configured to transfer the fuel from the day tank 102 to the generator 116. In some embodiments, the day tank 102 may be configured to receive the return fuel from the generator 116. The fuel management system 100 may comprise a fuel strainer 122. The fuel strainer 122 may be fluidly coupled to the day tank 102 and configured to remove debris and particulate matter from the fuel prior to entering the generator fuel pump 120. In some embodiments, the fuel strainer 122 may also be configured to promote fuel conditioning downstream of the day tank 102 by capturing suspended impurities while ensuring clean and continuous fuel delivery to the generator 116.

In some embodiments, the fuel management system 100 may comprise the fuel venting assembly 112. The fuel venting assembly 112 may be fluidly coupled to the day tank 102. Further, the fuel venting assembly 112 may be configured to vent air and vapor from the day tank 102. The primary purpose of the fuel vent assembly to keep the day tank near or at atmospheric pressure. This is important as a few things are happening. 1. As fuel is being pumped from the chassis tank to the day tank, air will need to be allowed to escape to prevent pressure build up. 2. As the generator is running, the fuel pump will be pumping fuel out of the day tank. Air will need to be let back into the tank as fuel is consumed. 3. Thermal expansion and contraction. 4. As air entrained fuel is returned to the day tank, it will release air into the day tank. Depending on the quantity of this air and the quantity of the fuel being consumed, the vent may need to allow air to escape the tank. In some embodiments, the fuel venting assembly 112 may comprise a float valve 130. The float valve 130 may be configured to prevent liquid fuel discharge during overfill conditions. In some embodiments, the fuel venting assembly 112 may further comprise a rollover valve 132. The rollover valve 132 may be configured to prevent fuel leakage during an inversion of the vehicle chassis.

The fuel management system 100 may comprise a fuel filter/water separator 134. The fuel filter/water separator 134 may be fluidly coupled between the generator fuel pump 120 and the generator 116. Further, the fuel filter/water separator 134 may be configured to remove smaller air bubbles introduced by the generator 116, prior to entering the generator 116. In some embodiments, the fuel filter/water separator 134 may also be configured to enhance fuel deaeration downstream of the day tank 102 by dissolving or further breaking up micro-bubbles while ensuring clean, dry, and continuous fuel delivery to the generator 116.

In some embodiments, the fuel management system 100 may further comprise a generator fuel supply line 126 and a generator fuel return line 128. The generator fuel supply line 126 may extend from the day tank 102, the fuel strainer 122, the generator fuel pump 120, the fuel filter/water separator 134 to the generator 116. The generator fuel supply line 126 may be configured to deliver fuel from the day tank 102 to the generator 116. The generator fuel return line 128 may be configured to return unused fuel from the generator to the day tank 102. In some embodiments, the day tank 102 may be configured to supply the fuel to at least one auxiliary fuel-consuming device 124. The at least one auxiliary fuel-consuming device 124 may be selected from a diesel-fired cabin heater and a diesel-fired water heater. In some embodiments, the day tank 102 may be configured to supply the fuel to at least one auxiliary fuel-consuming device 124. The at least one auxiliary fuel-consuming device 124 may be selected from a diesel-fired cabin heater and a diesel-fired water heater.

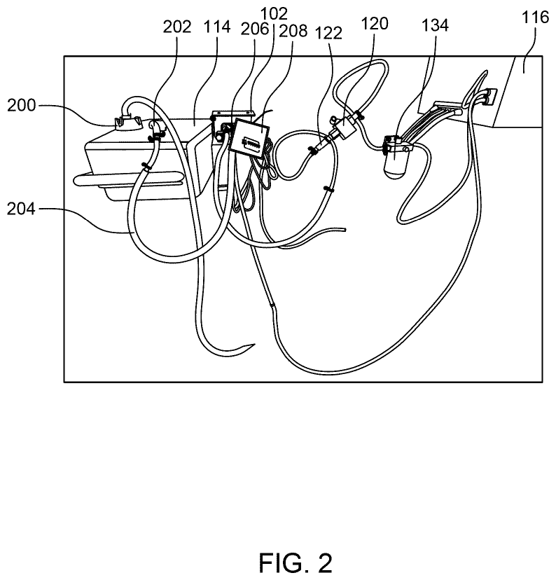

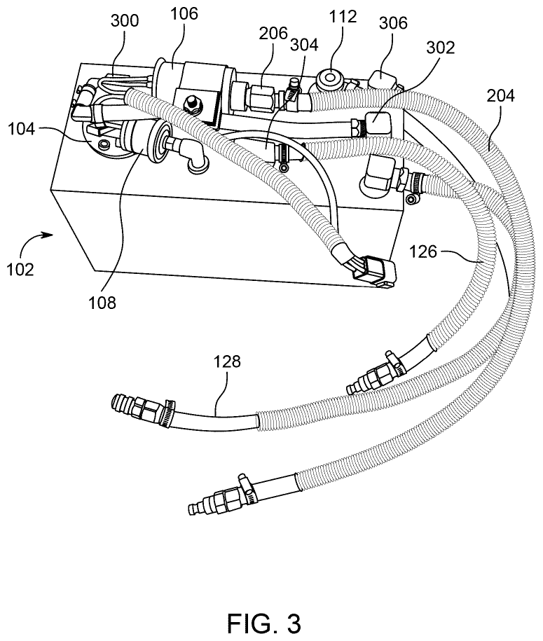

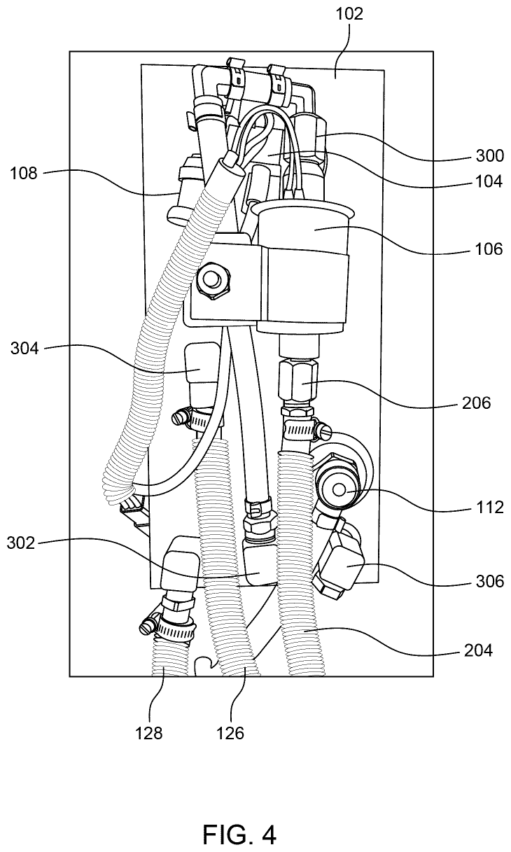

FIG. 2 illustrates an architectural view of a portion of the fuel management system 100, in accordance with an example embodiment of the present disclosure. FIG. 3 illustrates a perspective view of the day tank 102 of the fuel management system 100, in accordance with an example embodiment of the present disclosure. FIG. 4 illustrates a perspective view of the day tank fuel pump 106 of the fuel management system 100, in accordance with an example embodiment of the present disclosure.

In some embodiments, the chassis fuel tank 114 may be mounted on the vehicle chassis. In some embodiments, the chassis fuel tank 114 may be configured to store fuel. In some embodiments, the chassis fuel tank 114 may comprise an inlet port 200 and an outlet port 202 (which may also correspond to a manufacturer-provided fuel pickup port). Further, the inlet port 200 may be configured enable filling of the chassis fuel tank 114 with the fuel. The chassis fuel tank 114 may also be fluidly coupled with the OEM fuel pump. Further, the OEM fuel pump may be configured to supply the fuel from the chassis fuel tank 114 to the power train of the vehicle through fuel supply lines (not shown). In some embodiments, the chassis fuel tank 114 may include the manufacturer-provided auxiliary fuel pickup port (which correspond to the outlet port 202). The manufacturer-provided auxiliary fuel pickup port may have a predetermined depth that may terminate above a bottom of the chassis fuel tank 114 to prevent depletion of fuel required for chassis propulsion. In some embodiments, the outlet port 202 of the chassis fuel tank 114 may be fluidly coupled to the day tank fuel pump 106 through a day tank fuel supply line 204 (shown in FIG. 2). The day tank fuel pump 106 may be configured to receive the fuel from the day tank fuel supply line 204.

The fuel management system 100 may comprise the day tank 102. In some embodiments, the day tank 102 may be positioned separately from the chassis fuel tank 114. Further, the day tank 102 may be configured to receive fuel from the chassis fuel tank 114 through the day tank fuel pump 106. Further, the day tank 102 may be configured to receive return fuel from the generator 116 through the generator return fuel line 128. In some embodiments, the day tank 102 may be mounted at an elevation above an elevation of the chassis fuel tank 114 to inhibit siphoning of fuel from the chassis fuel tank 114 into the day tank 102 when the day tank fuel pump 106 may be deactivated. In some embodiments, the day tank 102 may be dimensioned to provide a reserve supply of fuel for the generator 116. The day tank fuel pump 106 may comprise a pump inlet port 206 (shown in FIG. 2) and a pump outlet port 300 (shown in FIG. 3). The day tank fuel pump 106 may be fluidly connected between the chassis fuel tank 114 and the day tank 102. The pump inlet port 206 may be fluidly coupled to the day tank fuel supply line 204 and the pump outlet port 300 may be fluidly coupled to the day tank 102. In some embodiments, the day tank fuel pump 106 may be configured to transfer the fuel from the chassis fuel tank 114 to the day tank 102.

In an exemplary embodiment, the fuel management system 100 may comprise a positive-shutoff fuel pump or an anti-siphon valve disposed along the day tank fuel supply line 204. The positive-shutoff fuel pump or the anti-siphon valve may be configured to automatically prevent unintended fuel flow when the day tank fuel pump 106 is deactivated, thereby inhibiting fuel siphoning regardless of elevation differences between the chassis fuel tank 114 and the day tank 102. In these embodiments, the day tank 102 may be mounted at any suitable location within the vehicle chassis, including elevations below, level with, or above the chassis fuel tank 114, without risk of passive fuel transfer.

As illustrated in FIG. 3, the day tank 102 may further comprise a day tank inlet port 302 and a day tank outlet port 304. In some embodiments, the day tank inlet port 302 may be fluidly coupled to the fuel pump outlet port 300. Further, the day tank fuel pump 106 may be configured to transfer the fuel from the chassis fuel tank 114 to the day tank 102 through the outlet port of the chassis fuel tank 114, the day tank fuel supply line 204, the fuel pump inlet port 206, the fuel pump outlet port 300, and the day tank inlet port 302. In some embodiments, the day tank 102 may be configured to supply the fuel to the generator 116 through the day tank outlet port 304. The generator 116 may comprise the generator fuel pump 120. The generator fuel pump 120 of the generator 116 may be configured to transfer the fuel from the day tank 102 to the generator 116. As illustrated in FIG. 2, the fuel management system 100 may further comprise a fuel level indicator 208. The fuel level indicator 208 may be coupled to the fuel level sensor 104. The fuel level indicator 208 may be configured to provide a real-time visual representation of the amount of fuel contained within the day tank 102.

The fuel management system 100 may further comprise the fuel strainer 122. The fuel strainer 122 may be fluidly coupled to the outlet (i.e. the day tank outlet port 304) of the day tank 102. In some embodiments. The fuel strainer 122 may be fluidly coupled to the day tank 102 through fuel supply lines. In some embodiments, the fuel strainer 122 may be configured to remove debris and particulate matter from the fuel, prior to entering the generator fuel pump 120. In some embodiments, the fuel strainer 122 may comprise a fine-mesh filtration element (not shown), a sediment collection chamber (not shown), or a multi-stage particulate-capture assembly (not shown) configured to retain solid contaminants and maintain fuel cleanliness. The fuel strainer 122 may further be configured to inhibit the transfer of abrasive particles and foreign matter to the generator fuel pump 120, thereby supporting consistent combustion performance and stable generator operation.

In some embodiments, the generator 116 may comprise the generator fuel pump 120. In some embodiments, the generator fuel pump 120 of the generator 116 may be fluidly coupled to the day tank 102. In some embodiments, the generator fuel pump 120 may be configured to provide the fuel to the generator 116. In some embodiments, the generator fuel pump 120 of the generator 116 may be configured to transfer the fuel from the day tank 102 to the generator 116. The generator fuel pump 120 may comprise at least an electric pump, mechanical pump, or diaphragm-type pump configured to generate sufficient suction and discharge pressure to transfer the fuel from the day tank 102 to the generator 116. In some embodiments, the generator fuel pump 120 may be configured to return excess fuel after consumption by the generator 116 to the day tank 102. In some embodiments, the day tank 102 may be configured to receive the return fuel from the generator 116.

The fuel management system 100 may comprise the fuel filter/water separator 134. The fuel filter/water separator 134 may be fluidly coupled between the generator fuel pump 120 and the generator 116. Further, the fuel filter/water separator 134 may be configured to remove smaller air bubbles introduced by the generator 116, prior to entering the generator 116. In some embodiments, the fuel filter/water separator 134 may comprise a fine-mesh filtration element (not shown), a water-separation chamber (not shown), or a flow-stabilizing cavity (not shown) configured to slow the flow of the fuel and promote separation of entrained air. The fuel filter/water separator 134 may further be configured to prevent particulate contaminants and moisture from reaching the generator 116, thereby supporting consistent combustion and stable generator operation. In some embodiments, the fuel filter/water separator 134 may also be configured to enhance fuel deaeration downstream of the day tank 102 by dissolving or further breaking up micro-bubbles while ensuring clean, dry, and continuous fuel delivery to the generator 116.

In some embodiments, the fuel management system 100 may further comprise the generator fuel supply line 126 and the generator fuel return line 128 (As shown in FIG. 1 and FIG. 3). The generator fuel supply line 126 may extend from the fuel strainer 122, the day tank fuel pump 106, the fuel filter/water separator 134 to the generator 116. The generator fuel supply line 126 may be configured to deliver fuel from the day tank 102 to the generator 116. Further, the generator fuel supply line 126 may comprise Society of Automotive Engineers (SAE)-rated fuel lines sized to reduce the formation of air pockets and reduce the number of required hose connections. In some embodiments, the fuel strainer 122 and the generator fuel supply line 126 may be arranged such that small air bubbles introduced by the generator 116 may be dissipated downstream of the fuel filter/water separator 134 prior to entering the generator 116. In some embodiments, the generator fuel pump 120 may be selected to provide a flow rate sufficient to overcome entrained-air accumulation within the generator fuel supply line 126. In some embodiments, the day tank 102 may be configured to supply the fuel to the at least one auxiliary fuel-consuming device 124 through an auxiliary fuel supply port 306. The at least one auxiliary fuel-consuming device 124 may be selected from the diesel-fired cabin heater and the diesel-fired water heater.

In some embodiments, the generator 116 may be configured to generate the power supply required for the on-board appliances of the vehicle. Further, the generator fuel pump 120 may be configured to return excess fuel after supplying the fuel to the generator 116. The generator fuel return line 128 may extend from the generator 116 to the day tank 102. The generator fuel return line 128 may be configured to return unused fuel from the generator 116 to the day tank 102. In some embodiments, the generator fuel return line 128 may be fluidly isolated from the chassis fuel tank 114 such that return fuel from the generator 116 may be prevented from entering the chassis fuel tank 114. In some embodiments, the generator fuel return line 128 may comprise the SAE-rated fuel lines sized to reduce the number of required hose connections. The day tank 102 may be configured to receive return fuel from the generator 116.

In some embodiments, the fuel management system 100 may comprise the fuel venting assembly 112. The fuel venting assembly 112 may be fluidly coupled to the day tank 102. Further, the fuel venting assembly 112 may be configured to vent air and vapor from the day tank 102 to provide deaeration of the return fuel received from the generator 116. The fuel venting assembly 112 also allows air and vapor to enter and escape as fuel is being consumed or the tank is being filled. In some embodiments, the fuel management system 100 may be configured such that deaerated fuel within the day tank 102 may be supplied to the generator 116 while entrained air in the return fuel may be removed due to natural means while the fuel is near undisturbed in the day tank 102. Some of this entrained air may exit the day tank 102 via the fuel venting assembly 112. In some embodiments, the fuel venting assembly 112 may comprise the float valve 130 (As shown in FIG. 1). The float valve 130 may be configured to prevent liquid fuel discharge during overfill conditions. In some embodiments, the fuel venting assembly 112 may further comprise the rollover valve 132 (As shown in FIG. 1). The rollover valve 132 may be configured to prevent fuel leakage during an inversion of the vehicle chassis.

In some embodiments, the fuel venting assembly 112 may further be configured to allow displacement of air from within the day tank 102 during active filling. For example, when the day tank fuel pump 106 may be operated to deliver fuel from the chassis fuel tank 114 into the day tank 102, the fuel venting assembly 112 may provide a controlled escape path for internal air volume displaced by incoming fuel. In such embodiments, the fuel venting assembly 112 may be configured to maintain continuous airflow out of the day tank 102 while preventing escape of the fuel.

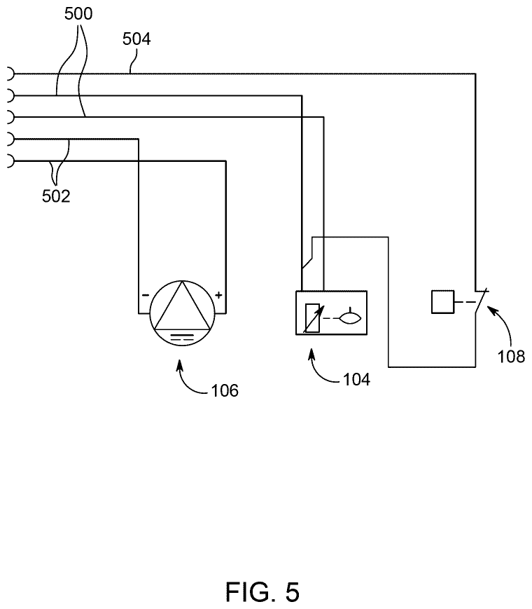

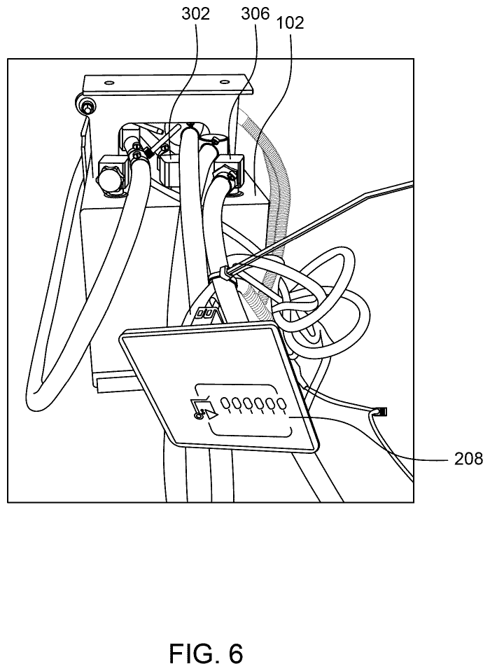

FIG. 5 illustrates a circuit diagram of the fuel management system 100, in accordance with an example embodiment of the present disclosure. FIG. 6 illustrates an architectural view showing the fuel level indicator 208 of the fuel management system 100, in accordance with an example embodiment of the present disclosure.

In some embodiments, the fuel level sensor 104 may be electrically connected to the control circuit 110 through a plurality of wiring paths 500, as illustrated in FIG. 5. Further, the control circuit 110 may be configured to continuously receive the fuel-level signal from the fuel level sensor 104. The control circuit 110 may further be configured to compare the fuel-level signal with the first threshold and the second threshold to determine whether the day tank 102 requires fuel replenishment or whether the filling operation should be stopped. The day tank fuel pump 106 may be configured to transfer the fuel from the chassis fuel tank 114 to the day tank 102. The day tank fuel pump 106 may be electrically coupled to the control circuit 110 through an actuation line 502, as shown in FIG. 5. When the fuel-level signal received by the control circuit 110 may indicate that the amount of fuel in the day tank 102 is below the first threshold, the control circuit 110 may be configured to actuate the day tank fuel pump 106. Upon actuation, the day tank fuel pump 106 may be configured to transfer the fuel into the day tank 102. Further, the fuel level sensor 104 may be configured to monitor and transmit updated fuel-level signals through the plurality of wiring paths 500.

Further, the control circuit 110 may be configured to monitor the fuel-level signal to determine whether the amount of fuel within the day tank 102 exceeds the second threshold. When the fuel-level signal indicates that the amount of fuel within the day tank 102 is above the second threshold, the control circuit 110 may be configured to deactivate the day tank fuel pump 106. The control circuit 110 may be configured to generate and communicate a deactivation signal through the actuation line 502. The pressure switch 108 may be fluidly coupled to the day tank 102 to monitor the internal pressure within the day tank 102. The pressure switch 108 may be electrically connected to the control circuit 110 and may be configured to generate the pressure signal when the over-pressure condition may be detected. The pressure switch 108 may be configured to transmit the pressure signal to the control circuit 110 through a deactivation line 504, as illustrated in FIG. 5. Upon receiving the pressure signal from the pressure switch 108, the control circuit 110 may be configured to deactivate the day tank fuel pump 106 irrespective of the amount of fuel transferred from the chassis fuel tank 114 to the day tank 102, thereby preventing additional pressure buildup and ensuring safe operation.

As illustrated in FIG. 6, the fuel management system 100 may further comprise the fuel level indicator 208. The fuel level indicator 208 may be coupled to the fuel level sensor 104. Further, the fuel level indicator 208 may be installed at least within the dashboard of the vehicle, a control panel associated with the generator 116, or any accessible location that allows the user to conveniently monitor the amount of fuel. The fuel level indicator 208 may be configured to provide a real-time visual representation of the amount of fuel contained within the day tank 102. In such embodiments, the fuel level indicator 208 may display the amount of fuel to the user. In some embodiments, the fuel level indicator 208 may comprise a digital display, an analog gauge, a bar-graph LED indicator, or any suitable visual interface. In some embodiments, the fuel level indicator 208 may be configured to clearly communicate the amount of fuel contained within the day tank 102 to the user.

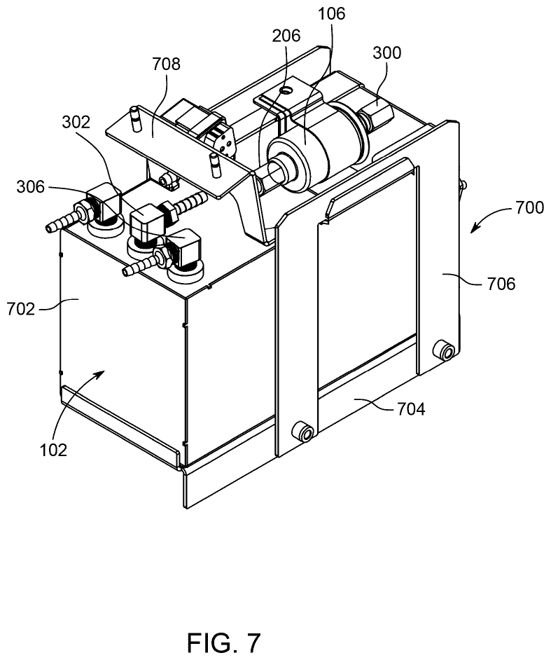

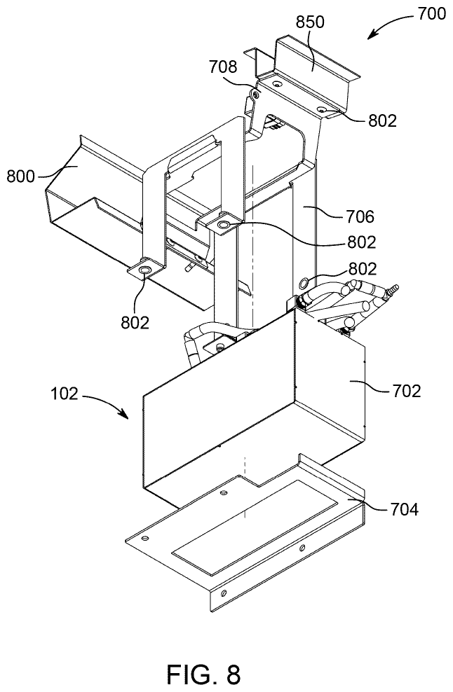

FIG. 7 illustrates an isometric view of the day tank 102 with a mounting assembly 700, in accordance with an example embodiment of the present disclosure. FIG. 8 illustrates an exploded view of the mounting assembly 700 of the day tank 102, in accordance with an example embodiment of the present disclosure.

In some embodiments, the day tank 102 may be dimensioned to provide a reserve supply of fuel for the generator 116. The day tank fuel pump 106 may comprise the pump inlet port 206 (shown in FIG. 2, FIG. 3, and FIG. 7) and the pump outlet port 300 (shown in FIG. 3 and FIG. 7). The day tank fuel pump 106 may be fluidly connected between the chassis fuel tank 114 and the day tank 102. The pump inlet port 206 may be fluidly coupled to the day tank fuel supply line 204 and the pump outlet port 300 may be fluidly coupled to the day tank 102. In some embodiments, the day tank fuel pump 106 may be configured to transfer fuel from the chassis fuel tank 114 to the day tank 102 through the day tank fuel supply line 204. The day tank 102 may comprise a housing 702. The housing 702 may be configured to enclose the fuel level sensor 104, the pressure switch 108, internal fuel-handling components, mechanical interfaces (not shown), and internal baffle structures. In an exemplary embodiment, the day tank 102 may further include integrated vibration-dampening components (not shown), such as elastomeric isolators or rubberized bushings, configured to reduce the transfer of vibration from the day tank 102 to the mounting assembly 700 and the vehicle chassis during operation.

In some embodiments, the day tank 102 may be mounted within the vehicle through the mounting assembly 700. The mounting assembly 700 may be configured to secure the day tank 102 to the vehicle chassis. The mounting assembly 700 may comprise a base plate 704 and a plurality of structural brackets 706 configured to support and stabilize the day tank 102. The base plate 704 of the mounting assembly 700 may be configured to receive and support the housing 702 of the day tank 102. The base plate 704 may include reinforced regions to withstand weight of the day tank 102 and dynamic vehicle loads. The plurality of structural brackets 706 may extend upward from the base plate 704, each bracket configured to engage sides of the housing 702 to prevent lateral displacement or oscillation of the day tank 102.

The mounting assembly 700 may further comprise an upper clamping bracket 708. The upper clamping bracket 708 may be positioned above the day tank 102. The upper clamping bracket 708 may be configured to engage with the housing 702 to provide additional vertical restraint to the day tank 102. In some embodiments, the mounting assembly 700 may be detachably coupled to the vehicle chassis. The base plate 704 may include mounting slots or bolt apertures configured to align with chassis mounting points, allowing the mounting assembly 700 to be secured using removable hardware. The mounting assembly 700 may also be configured to maintain alignment of the day tank 102, prevent rotational movement, and reduce the transmission of vibration and noise into the vehicle body.

As illustrated in FIG. 8, the day tank 102 may be supported by the mounting assembly 700 configured to be detachably coupled to the vehicle chassis. The mounting assembly 700 may comprise a plurality of support plates 800, and fastening hardware 802 arranged to securely retain the day tank 102 during vehicle operation. In some embodiments, the day tank 102 may be mounted at an elevation above the chassis fuel tank 114 to inhibit siphoning of fuel from the chassis fuel tank 114 into the day tank 102 when the day tank fuel pump 106 is deactivated. In an exemplary embodiment, the mounting assembly 700 may be formed of rigid metal members shaped to provide lateral, vertical, and torsional stability, and may incorporate flanges, bolt holes, or reinforced connection regions to facilitate secure attachment. The mounting assembly 700 may be fastened together using bolts, nuts, or other removable hardware to enable tool-assisted installation and removal. The connection between 708 and 800, and also between 708 and 900 are both done using pop rivets. Therefore they would not be tool assisted removal.

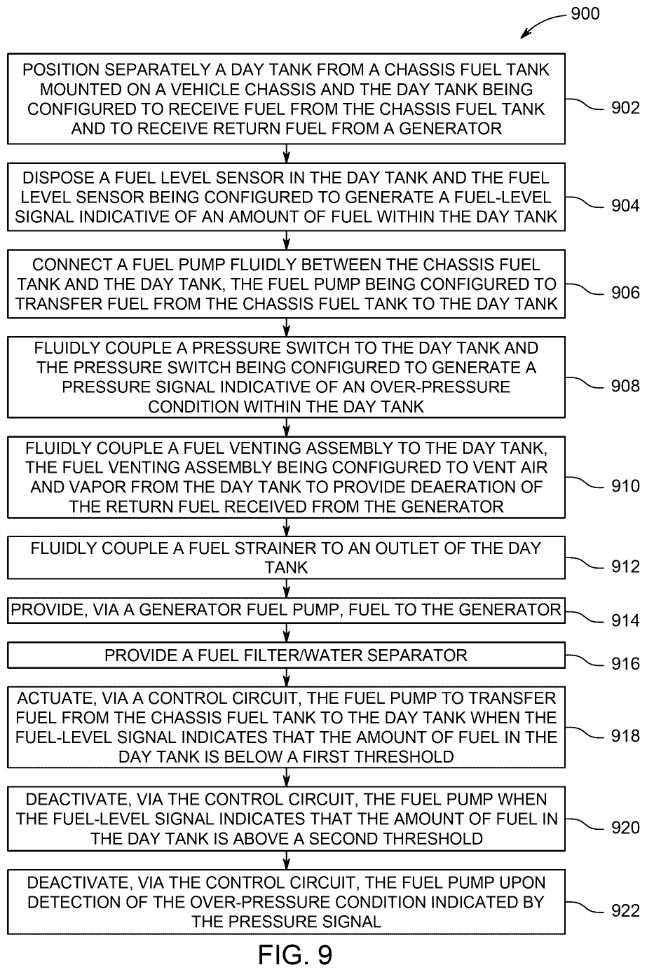

FIG. 9 illustrates a flowchart showing a method 900, in accordance with an example embodiment of the present disclosure.

At operation 902, the day tank 102 is positioned separately from the chassis fuel tank 114 mounted on the vehicle chassis and the day tank 102 being configured to receive fuel from the chassis fuel tank 114 and to receive return fuel from the generator 116. In some embodiments, the day tank 102 may be configured to operate as an intermediate fuel reservoir between the chassis fuel tank 114 and the generator 116. The day tank 102 may be configured to maintain a predetermined amount of fuel to ensure a consistent fuel availability for the generator 116 during varying load conditions, chassis angles, and dynamic acceleration.

At operation 904, the fuel level sensor 104 is disposed in the day tank 102, the fuel level sensor 104 being configured to generate the fuel-level signal indicative of the amount of fuel within the day tank 102. The fuel level sensor 104 may comprise one or more sensing elements such as a float-based mechanism, a resistive strip, a capacitive probe, an ultrasonic sensing unit, reed switches, or the like. The one or more sensing elements configured to detect the amount of fuel within the day tank 102. Further, the fuel level sensor 104 may be configured to generate a fuel-level signal indicative of the amount of fuel within the day tank 102. The fuel level sensor 104 may be an ohmic-based resistive sensor configured to generate a resistance value corresponding to the amount of fuel in the day tank 102. In some embodiments, the fuel level sensor 104 may be operatively coupled to the control circuit 110. The fuel level sensor 104 may be configured to transmit the fuel-level signal to the control circuit 110.

At operation 906, the day tank fuel pump 106 is connected fluidly between the chassis fuel tank 114 and the day tank 102, the day tank fuel pump 106 being configured to transfer fuel from the chassis fuel tank 114 to the day tank 102. The day tank fuel pump 106 may comprise at least an electric pump, mechanical pump, or diaphragm-type pump configured to generate sufficient suction and discharge pressure to transfer the fuel from the chassis fuel tank 114 to the day tank 102.

At operation 908, the pressure switch 108 is fluidly coupled to the day tank 102 and the pressure switch 108 being configured to generate the pressure signal indicative of an over-pressure condition within the day tank 102. In some embodiments, the pressure switch 108 may be fluidly connected to the day tank 102 through a dedicated pressure port or integrated pressure sensing interface. The pressure switch 108 may be configured to continuously monitor the internal pressure conditions within the day tank 102 and generate the pressure signal indicative of the over-pressure condition.

At operation 910, the fuel venting assembly 112 is fluidly connected to the day tank 102, the fuel venting assembly 112 being configured to vent air and vapor from the day tank 102 to provide deaeration of the return fuel received from the generator 116. In some embodiments, the fuel management system 100 may be configured such that deaerated fuel within the day tank 102 may be supplied to the generator 116 while entrained air in the return fuel may be removed due to natural means while the fuel is near undistrubed in the day tank 102. Some of this entrained air may exit the day tank 102 via the fuel venting assembly 112. The fuel venting assembly 112 may comprise one or more vent ports, vapor separation chambers, or controlled vent valves configured to allow trapped air or vapor to escape while retaining the fuel within the day tank 102. In an exemplary embodiment, the fuel venting assembly 112 may support stable fuel circulation by preventing air accumulation within the day tank 102, thereby ensuring consistent fuel delivery pressure.

At operation 912, the fuel strainer 122 is fluidly coupled to the outlet of the day tank 102. In some embodiments, the fuel strainer 122 may be configured to remove debris and particulate matter from the fuel, prior to entering the generator fuel pump 120. In some embodiments, the fuel strainer 122 may comprise a fine-mesh filtration element (not shown), a sediment collection chamber (not shown), or a multi-stage particulate-capture assembly (not shown) configured to retain solid contaminants and maintain fuel cleanliness. The fuel strainer 122 may further be configured to inhibit the transfer of abrasive particles and foreign matter to the generator fuel pump 120, thereby supporting consistent combustion performance and stable generator operation.

At operation 914, the generator fuel pump 120 provides the fuel to the generator 116. In some embodiments, the generator fuel pump 120 of the generator 116 may be fluidly coupled to the day tank 102. In some embodiments, the generator fuel pump 120 of the generator 116 may be configured to transfer the fuel from the day tank 102 to the generator 116. The generator fuel pump 120 may comprise at least an electric pump, mechanical pump, or diaphragm-type pump configured to generate sufficient suction and discharge pressure to transfer the fuel from the day tank 102 to the generator 116. In some embodiments, the generator fuel pump 120 may be configured to return excess fuel after consumption by the generator 116 to the day tank 102. In some embodiments, the day tank 102 may be configured to receive the return fuel from the generator 116.

At operation 916, the fuel filter/water separator 134 is provided. The fuel filter/water separator 134 may be fluidly coupled between the generator fuel pump 120 and the generator 116. Further, the fuel filter/water separator 134 may be configured to remove smaller air bubbles introduced by the generator 116, fuel transfer process, and generator fuel pump 120 prior to entering the generator 116. In some embodiments, the fuel filter/water separator 134 may comprise a fine-mesh filtration element (not shown), a water-separation chamber (not shown), or a flow-stabilizing cavity (not shown) configured to slow the flow of the fuel and promote separation of entrained air. The fuel filter/water separator 134 may further be configured to prevent particulate contaminants and moisture from reaching the generator 116, thereby supporting consistent combustion and stable generator operation. In some embodiments, the fuel filter/water separator 134 may also be configured to enhance fuel deaeration downstream of the day tank 102 by dissolving or further breaking uptrapped micro-bubbles while ensuring clean, dry, and continuous fuel delivery to the generator 116.

At operation 918, the control circuit 110 actuates the day tank fuel pump 106 to transfer fuel from the chassis fuel tank 114 to the day tank 102 when the fuel-level signal indicates that the amount of fuel in the day tank 102 is below the first threshold. Upon actuating, the day tank fuel pump 106 may be configured to transfer the fuel from the chassis fuel tank 114 to the day tank 102. For example, the day tank 102 may have a total capacity of 1.9 gallons. The fuel-level signal may indicate that the day tank 102 currently contains less than 30% of its capacity, such as approximately 0.6 gallons of fuel. The first threshold may correspond to 40% of the day tank 102 capacity, such as approximately 0.8 gallons. In such scenarios, the control circuit 110 may be configured to actuate the day tank fuel pump 106 when the fuel-level signal may indicate that the amount of fuel in the day tank 102 is below the first threshold. Upon actuating, the day tank fuel pump 106 may be configured to transfer the fuel from the chassis fuel tank 114 to the day tank 102.

At operation 920, the control circuit 110 deactivates the day tank fuel pump 106 when the fuel-level signal indicates that the amount of fuel in the day tank 102 is above the second threshold. Upon deactivation, the day tank fuel pump 106 may stop transferring of the fuel from the chassis fuel tank 114 to the day tank 102. For example, the second threshold may correspond to more than 90% of the day tank 102 capacity, such as approximately 1.7 gallons. Further, the control circuit 110 may be configured to deactivate the day tank fuel pump 106 when the fuel-level signal may indicate that the amount of fuel in the day tank 102 is above the second threshold. Upon deactivation, the day tank fuel pump 106 may stop transferring the fuel from the chassis fuel tank 114 to the day tank 102.

At operation 922, the control circuit 110 deactivates the day tank fuel pump 106 upon detection of the over-pressure condition indicated by the pressure signal. For example, the day tank 102 may be designed to operate at a nominal internal pressure of near 0 psi during normal fuel transfer. Further, the pressure switch 108 may be configured to generate the pressure signal when the internal pressure of the day tank 102 exceeds an over-pressure threshold, such as 2 psi. In some embodiments, the control circuit 110 may be configured to deactivate the day tank fuel pump 106 upon detection of the over-pressure condition indicated by the pressure signal. Upon deactivation, the day tank fuel pump 106 may stop transferring fuel from the chassis fuel tank 114 to the day tank 102 to prevent further pressure build-up and ensure safe operation.

The present disclosure offers several notable advantages of the fuel management system 100. The fuel management system 100 enables controlled, reliable, and uninterrupted delivery of fuel from the vehicle chassis tank to the vehicle-mounted day tank 102 and then to the generator 116, ensuring consistent power generation across a wide range of operating conditions. The coordinated operation of the day tank fuel pump 106, the fuel level sensor 104, the pressure switch 108, and the control circuit 110 maintains optimal fuel levels, prevents over-pressure events, and mitigates risks associated with fuel starvation or overflow, thereby promoting smooth operation with minimal vibration and noise. From a safety and efficiency perspective, the use of diesel fuel reduces the risk of explosion, minimizes carbon monoxide generation, and ensures stable performance across diverse temperature environments. The unified diesel-based configuration eliminates the need for LP fuel systems, simplifying installation, reducing system complexity, and freeing up valuable vehicle space previously occupied by LP tanks and associated components. Additionally, the reduction in component count lowers installation time, decreases maintenance requirements, and contributes to overall cost-effectiveness for the vehicle manufacturer or end user.

Many modifications and other embodiments of the present disclosure set forth herein will come to mind to one skilled in the art to which this present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fuel management system for supplying fuel to a generator mounted on a vehicle chassis comprising a chassis fuel tank, the fuel management system comprising:
a day tank positioned separately from the chassis fuel tank and configured to receive fuel from the chassis fuel tank and to receive return fuel from the generator;
a fuel level sensor disposed in the day tank and configured to generate a fuel-level signal indicative of an amount of the fuel within the day tank;
a day tank fuel pump fluidly connected between the chassis fuel tank and the day tank, the fuel pump being configured to transfer the fuel from the chassis fuel tank to the day tank;
a pressure switch fluidly coupled to the day tank and configured to generate a pressure signal indicative of an over-pressure condition within the day tank;
a fuel venting assembly fluidly coupled to the day tank and configured to vent air and vapor from the day tank to provide deaeration of the return fuel received from the generator;
a fuel strainer fluidly coupled to an outlet of the day tank;
a generator fuel pump to provide fuel to the generator;
a fuel filter/water separator; and
a control circuit operatively coupled to the fuel level sensor, the fuel pump, and the pressure switch, the control circuit being configured to:
actuate the day tank fuel pump to transfer fuel from the chassis fuel tank to the day tank when the fuel-level signal indicates that the amount of fuel in the day tank is below a first threshold;
deactivate the day tank fuel pump when the fuel-level signal indicates that the amount of fuel in the day tank is above a second threshold; and
deactivate the day tank fuel pump upon detection of the over-pressure condition indicated by the pressure signal.

2. The fuel management system of claim 1, wherein the fuel management system is configured such that deaerated fuel within the day tank is supplied to the generator while entrained air in the return fuel is removed through the fuel venting assembly.

3. The fuel management system of claim 1 further comprising:
a generator fuel supply line extending from the fuel strainer, day tank fuel pump, fuel filter/water separator to the generator and configured to deliver fuel from the day tank to the generator; and
a generator fuel return line extending from the generator to the day tank and configured to return unused fuel from the generator to the day tank,
wherein the generator fuel return line is fluidly isolated from the chassis fuel tank such that return fuel from the generator is prevented from entering the chassis fuel tank.

4. The fuel management system of claim 1, wherein the fuel venting assembly comprises a float valve configured to prevent liquid fuel discharge during overfill conditions, and further comprises a rollover valve configured to prevent fuel leakage during an inversion of the vehicle chassis.

5. The fuel management system of claim 1, wherein the control circuit is further configured to prevent activation of the fuel pump when a fuel level of the chassis fuel tank is below a predetermined chassis-fuel threshold.

6. The fuel management system of claim 1, wherein the control circuit is further configured to deactivate the fuel pump when the fuel pump has operated continuously for a predetermined maximum runtime without the fuel level sensor indicating that the amount of fuel in the day tank has reached the second threshold.

7. The fuel management system of claim 6, wherein the control circuit is further configured to inhibit subsequent activation of the fuel pump after expiration of the predetermined maximum runtime until at least one of: (i) a timeout interval has elapsed; or (ii) electrical power to the control circuit has been cycled.

8. The fuel management system of claim 1, wherein the generator fuel pump is selected to provide a flow rate sufficient to overcome entrained-air accumulation within the generator fuel supply line during generator restart conditions.

9. The fuel management system of claim 1, wherein the generator fuel supply line and the generator fuel return line comprise SAE-rated fuel lines sized to reduce the formation of air pockets and reduce the number of required hose connections.

10. The fuel management system of claim 1, wherein the fuel filter/water separator and the generator fuel supply line are arranged such that small air bubbles introduced by the generator are dissipated within the fuel filter/water separator prior to entering the generator.

11. The fuel management system of claim 1, wherein the day tank is mounted at an elevation above an elevation of the chassis fuel tank to inhibit siphoning of fuel from the chassis fuel tank into the day tank when the fuel pump is deactivated.

12. The fuel management system of claim 1, wherein the day tank is configured to supply diesel fuel to at least one auxiliary fuel-consuming device selected from: (i) a diesel-fired cabin heater; and (ii) a diesel-fired water heater.

13. The fuel management system of claim 1, wherein the day tank is dimensioned to provide a reserve supply of fuel for the generator.

14. The fuel management system of claim 1, wherein the chassis fuel tank includes a manufacturer-provided fuel pickup port having a predetermined depth that terminates above a bottom of the chassis fuel tank to prevent depletion of fuel required for chassis propulsion.

15. The fuel management system of claim 1, wherein the control circuit is further configured to maintain the fuel level in the day tank within an operating band between approximately 40 percent and 90 percent of a capacity of the day tank during generator operation.

16. A method comprising:
positioning separately a day tank from a chassis fuel tank mounted on a vehicle chassis and the day tank being configured to receive fuel from the chassis fuel tank and to receive return fuel from a generator;
disposing a fuel level sensor in the day tank, the fuel level sensor being configured to generate a fuel-level signal indicative of an amount of fuel within the day tank;
connecting a day tank fuel pump fluidly between the chassis fuel tank and the day tank, the fuel pump being configured to transfer fuel from the chassis fuel tank to the day tank;
fluidly coupling a pressure switch to the day tank and the pressure switch being configured to generate a pressure signal indicative of an over-pressure condition within the day tank;
fluidly coupling a fuel venting assembly to the day tank, the fuel venting assembly being configured to vent air and vapor from the day tank to provide deaeration of the return fuel received from the generator;
fluidly coupling a fuel strainer to an outlet of the day tank;
providing, via a generator fuel pump, fuel to the generator;
providing a fuel filter/water separator;
actuating, via a control circuit, the day tank fuel pump to transfer fuel from the chassis fuel tank to the day tank when the fuel-level signal indicates that the amount of fuel in the day tank is below a first threshold;
deactivating, via the control circuit, the day tank fuel pump when the fuel-level signal indicates that the amount of fuel in the day tank is above a second threshold; and
deactivating, via the control circuit, the day tank fuel pump upon detection of the over-pressure condition indicated by the pressure signal.

17. The method of claim 16, further comprising supplying, via the fuel management system, deaerated fuel within the day tank to the generator while entrained air in the return fuel is removed due to natural means while the fuel is near undisturbed in the day tank. Some of this entrained air may exit the day tank via the fuel venting assembly.

18. The method of claim 16 further comprising:
delivering, via a generator fuel supply line extending from the fuel strainer, day tank fuel pump, fuel filter/water separator to the generator, fuel from the day tank to the generator; and
returning, via a generator fuel return line extending from the generator to the day tank, unused fuel from the generator to the day tank,
wherein the generator fuel return line is fluidly isolated from the chassis fuel tank such that return fuel from the generator is prevented from entering the chassis fuel tank.

19. The method of claim 16, further comprising preventing, via a float valve, liquid fuel discharge during overfill conditions, wherein the fuel venting assembly further comprises a rollover valve configured to prevent fuel leakage during an inversion of the vehicle chassis.

20. The method of claim 16 further comprising, preventing, via the control circuit, activation of the fuel pump when a fuel level of the chassis fuel tank is below a predetermined chassis-fuel threshold.
